(19) United States
(12) Patent Application Publication
(10) Pub. No.: US 2026/0079338 A1
(43) Pub. Date: Mar. 19, 2026

(54) MIRROR DEVICE AND OPTICAL SCANNING DEVICE

(71) Applicant: FUJIFILM Corporation, Tokyo (JP)

(72) Inventor: Keisuke AOSHIMA, Kanagawa (JP)

(73) Assignee: FUJIFILM Corporation, Tokyo (JP)

(21) Appl. No.: 19/357,422

(22) Filed: Oct. 14, 2025

Related U.S. Application Data
(63) Continuation of application No. PCT/JP2024/011413, filed on Mar. 22, 2024.

(30) Foreign Application Priority Data
Apr. 17, 2023 (JP) 2023-067490

(51) Int. Cl. G02B 26/10

(52) U.S. Cl. CPC G02B 26/101

(57) ABSTRACT

A mirror device includes a mirror portion, a pair of first support portions, a driving unit, a fixed frame that is disposed to surround the driving unit, and a pair of connecting portions that connect the driving unit to the fixed frame, in which each of the pair of connecting portions has a slit, and the slit is disposed at a position where the slit is line-symmetric with respect to a first axis or a second axis intersecting the first axis as a symmetry axis.

### CROSS-REFERENCE TO RELATED APPLICATIONS

This application is a continuation application of International Application No. PCT/JP2024/011413, filed Mar. 22, 2024, the disclosure of which is incorporated herein by reference in its entirety. Further, this application claims priority from Japanese Patent Application No. 2023-067490, filed on Apr. 17, 2023, the disclosure of which is incorporated herein by reference in its entirety.

### BACKGROUND

### 1. Technical Field

The technology of the present disclosure relates to a mirror device and an optical scanning device.

### 2. Description of the Related Art

A micromirror device (also referred to as a microscanner) is known as one of micro electro mechanical systems (MEMS) devices manufactured using the silicon (Si) nanofabrication technique. Since the micromirror device is small and has low power consumption, it is expected to have a wide range of applications in laser displays, laser projectors, optical coherence tomography, and the like.

There are various methods for driving the micromirror device, and a piezoelectric drive method using deformation of a piezoelectric material is promising since the generated torque is higher than that in other methods and a high scan angle can be obtained. In particular, in a case where a high scan angle is required, such as in a laser display, a higher scan angle can be obtained by resonantly driving the micromirror device of the piezoelectric drive method.

A general micromirror device used in a laser display comprises a mirror portion and a piezoelectric actuator (see, for example, JP2017-132281A). The mirror portion is swingable around a first axis and a second axis that are orthogonal to each other. The actuator is a driving unit that causes the mirror portion to swing around a first axis and a second axis in accordance with a driving voltage supplied from the outside.

### SUMMARY

As performance indicators of the laser display, resolution and viewing angle are mentioned. The resolution and the viewing angle are greatly affected by the swing frequency and the deflection angle of the mirror portion. For example, in a Lissajous scanning type laser display, a mirror portion performs two-dimensional optical scanning by simultaneously swinging around a first axis and a second axis at different frequencies. In this case, as the deflection angle of the mirror portion increases, the scanning area of light increases, and a larger image can be displayed with a shorter optical path length.

In a case where the deflection angle of the mirror portion is increased, stress generated at a specific portion of the micromirror device increases. In a case where the stress reaches the limit value in the structure, the structural destruction occurs. Therefore, in the actual specifications of the micromirror device, it is common to drive the micromirror device by relaxing the stress concentration by increasing the structure of each part and within a stress range that is sufficiently smaller than the limit value. However, in a case where the structure of each portion is increased in order to relieve the stress concentration, the micromirror device is increased in size. In addition, in the driving in a range of a stress that is sufficiently smaller than the limit value, the deflection angle of the mirror portion cannot be sufficiently increased.

An object of the technology of the present disclosure is to provide a mirror device and an optical scanning device that can suppress structural destruction during driving and realize a large deflection angle.

In order to achieve the above object, a mirror device according to the present disclosure comprises a mirror portion that has a reflecting surface for reflecting incident light, a pair of first support portions that are connected to the mirror portion on a first axis parallel to the reflecting surface in a stationary state of the mirror portion and that swingably support the mirror portion around the first axis, a driving unit that is connected to the pair of first support portions and that drives the mirror portion, a fixed frame that is disposed to surround the driving unit, and a pair of connecting portions that connect the driving unit to the fixed frame, in which each of the pair of connecting portions has a slit, the slit is disposed at a position line-symmetric with respect to the first axis or a second axis as a symmetry axis, the second axis being parallel to the reflecting surface in a stationary state of the mirror portion and intersecting the first axis, and the fixed frame includes a pair of beam portions that are in contact with the pair of connecting portions and that extend in a first direction parallel to the symmetry axis, and a maximum value of a width of each of the pair of beam portions in a second direction parallel to the reflecting surface and orthogonal to the first direction is greater than a distance from an outermost end of the fixed frame in the second direction to the slit.

It is preferable that the pair of connecting portions are disposed on the second axis at positions facing each other across the first axis.

It is preferable that the slit is disposed on the second axis and extends in a direction parallel to the first axis.

It is preferable that the connecting portion has a thickness smaller than a thickness of the fixed frame.

It is preferable that a connection boundary between the connecting portion and the fixed frame has a protruding portion of which a part protrudes toward a slit side.

It is preferable that the protruding portion is close to the slit on the second axis.

It is preferable that the mirror device according to the present disclosure further comprises a pair of movable frames that are connected to the first support portions and that disposed to face each other across the first axis, and a pair of second support portions that are connected to the movable frames on the second axis and that swingably support the mirror portion, the pair of first support portions, and the pair of movable frames around the second axis, in which the driving unit is connected to the pair of second support portions and is disposed to surround the pair of movable frames.

It is preferable that the driving unit includes a pair of first actuators that are connected to the pair of second support portions, that face each other across the second axis, and that each include a piezoelectric element, and a pair of second actuators that are disposed to surround the pair of first actuators, that face each other across the first axis, and that each include a piezoelectric element.

An optical scanning device according to the present disclosure comprises the mirror device described above, and a processor that drives the driving unit, in which the processor causes the mirror portion to swing by applying a drive signal to the driving unit.

According to the technology of the present disclosure, it is possible to provide a mirror device and an optical scanning device that can suppress structural destruction during driving and realize a large deflection angle.

### BRIEF DESCRIPTION OF THE DRAWINGS

Exemplary embodiments according to the technique of the present disclosure will be described in detail based on the following figures, wherein:

FIG. 1 is a schematic view of an optical scanning device,

FIG. 2 is a block diagram showing an example of a hardware configuration of a driving controller,

FIG. 3 is an external perspective view of a micromirror device according to the first embodiment,

FIG. 4 is a plan view of the micromirror device according to the first embodiment as viewed from a light incident side,

FIG. 5 is a perspective view showing a part of a rear surface side of the micromirror device according to the first embodiment,

FIG. 6 is a cross-sectional view taken along a line A-A in FIG. 4,

FIG. 7 is a cross-sectional view showing a state where a mirror portion rotates around a first axis,

FIGS. 8A and 8B are diagrams showing examples of a first drive signal and a second drive signal,

FIG. 9 is a diagram showing parameters relating to dimensions of components of the micromirror device,

FIG. 10 is a diagram showing parameters relating to dimensions of components of the micromirror device,

FIG. 11 is a diagram showing parameters relating to dimensions of components of the micromirror device,

FIG. 12 is a diagram showing specific set values of the parameters,

FIG. 13 is a plan view of the micromirror device according to the second embodiment as viewed from a light incident side,

FIG. 14 is a diagram showing parameters relating to dimensions of components of the micromirror device,

FIG. 15 is a diagram showing parameters relating to dimensions of components of the micromirror device,

FIG. 16 is a diagram showing parameters relating to dimensions of components of the micromirror device,

FIG. 17 is a diagram showing specific set values of the parameters,

FIG. 18 is a plan view of the micromirror device according to the third embodiment as viewed from a light incident side,

FIG. 19 is a diagram showing parameters relating to dimensions of components of the micromirror device,

FIG. 20 is a diagram showing parameters relating to dimensions of components of the micromirror device,

FIG. 21 is a diagram showing parameters relating to dimensions of components of the micromirror device,

FIG. 22 is a diagram showing parameters relating to dimensions of components of the micromirror device,

FIG. 23 is a diagram showing specific set values of the parameters,

FIG. 24 is a plan view of a micromirror device according to a first comparative example as viewed from a light incident side,

FIG. 25 is a diagram showing parameters relating to dimensions of components of the micromirror device,

FIG. 26 is a diagram showing parameters relating to dimensions of components of the micromirror device,

FIG. 27 is a diagram showing parameters relating to dimensions of components of the micromirror device,

FIG. 28 is a diagram showing specific set values of the parameters,

FIG. 29 is a plan view of a micromirror device according to a second comparative example as viewed from a light incident side,

FIG. 30 is a diagram showing parameters relating to dimensions of components of the micromirror device,

FIG. 31 is a diagram showing parameters relating to dimensions of components of the micromirror device,

FIG. 32 is a diagram showing parameters relating to dimensions of components of the micromirror device,

FIG. 33 is a diagram showing specific set values of the parameters,

FIG. 34 is a diagram showing simulation results according to each of the embodiments and each of comparative examples,

FIG. 35 is a contour diagram showing a stress distribution applied to a fixed frame connecting portion of the micromirror device according to the first embodiment,

FIG. 36 is a contour diagram showing a stress distribution applied to the fixed frame connecting portion of the micromirror device according to the first embodiment,

FIG. 37 is a contour diagram showing a stress distribution applied to a fixed frame connecting portion of the micromirror device according to the first comparative example, and

FIG. 38 is a contour diagram showing a stress distribution applied to a fixed frame connecting portion of the micromirror device according to the first comparative example.

### DETAILED DESCRIPTION

An example of an embodiment according to the technology of the present disclosure will be described with reference to the accompanying drawings.

### First Embodiment

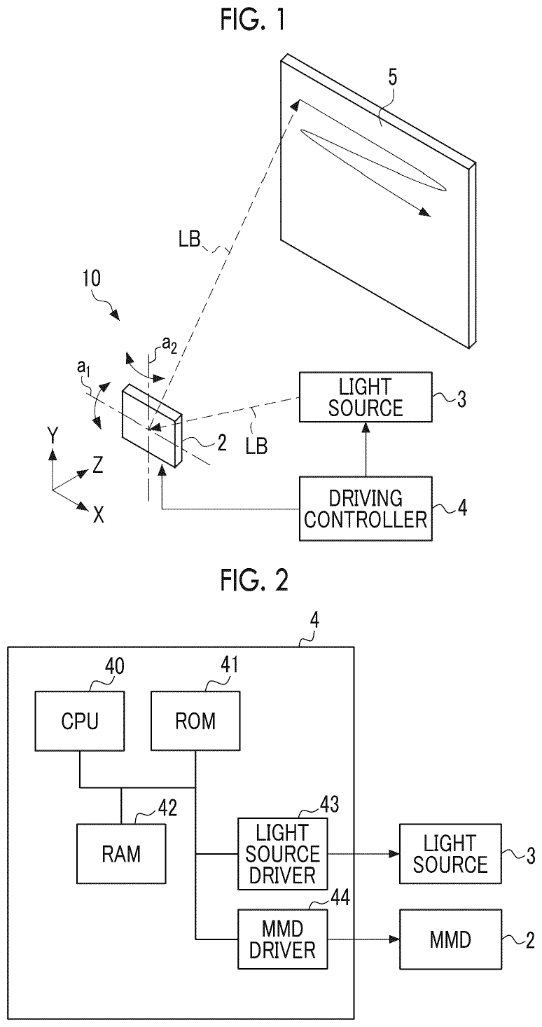

FIG. 1 is a schematic view of an optical scanning device 10 according to the first embodiment. The optical scanning device 10 includes a micromirror device (hereinafter, referred to as micromirror device (MMD)) 2, a light source 3, and a driving controller 4. The optical scanning device 10 optically scans a surface to be scanned 5 by reflecting a light beam LB emitted from the light source 3 by the MMD 2 under the control of the driving controller 4. The surface to be scanned 5 is a screen, a retina of an eye, or the like. The MMD 2 is an example of a “mirror device” according to the technology of the present disclosure.

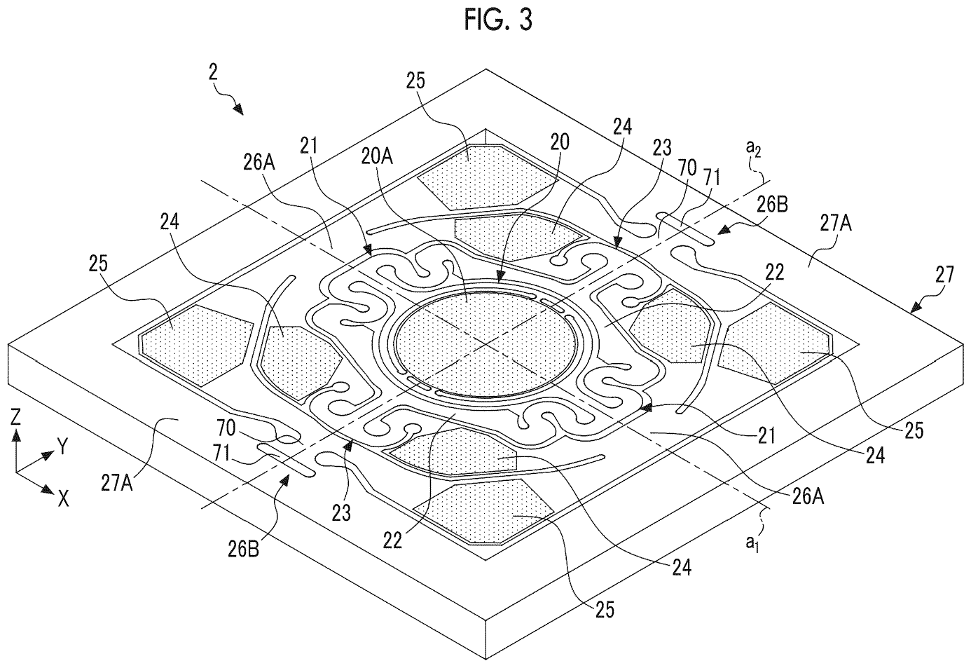

The MMD 2 is a piezoelectric biaxial drive-type micromirror device capable of allowing a mirror portion 20 (see FIG. 3) to swing around a first axis a₁ and a second axis a₂ orthogonal to the first axis a₁. Hereinafter, a direction parallel to the first axis a₁ is referred to as an X direction, a direction parallel to the second axis a₂ is a Y direction, and a direction orthogonal to the first axis a₁ and the second axis a₂ is referred to as a Z direction. In the present embodiment, an example in which the first axis a₁ is orthogonal to (that is, perpendicularly intersects with) the second axis a₂ is shown, but the first axis a₁ may intersect with the second axis a₂ at an angle other than 90°. Here, the intersection refers to an intersection within a certain angle range including an allowable error, centered on 90°.

The light source 3 is a laser device that emits, for example, laser light as the light beam LB. It is preferable that the light source 3 emits the light beam LB perpendicularly to a reflecting surface 20A (see FIG. 3) included in the mirror portion 20 in a state where the mirror portion 20 of the MMD 2 is stationary.

The driving controller 4 outputs a drive signal to the light source 3 and the MMD 2 based on optical scanning information. The light source 3 generates the light beam LB based on the input drive signal and emits the light beam LB to the MMD 2. The MMD 2 allows the mirror portion 20 to swing around the first axis a₁ and the second axis a₂ based on the input drive signal.

As will be described in detail below; the driving controller 4 allows the mirror portion 20 to resonate around the first axis a₁ and the second axis a₂, so that the surface to be scanned 5 is scanned with the light beam LB reflected by the mirror portion 20 such that a Lissajous waveform is drawn. This optical scanning method is called a Lissajous scanning method.

The optical scanning device 10 is applied to, for example, a Lissajous scanning type laser display. Specifically, the optical scanning device 10 can be applied to a laser scanning display such as augmented reality (AR) glasses or virtual reality (VR) glasses.

FIG. 2 shows an example of a hardware configuration of the driving controller 4. The driving controller 4 has a central processing unit (CPU) 40, a read only memory (ROM) 41, a random access memory (RAM) 42, a light source driver 43, and an MMD driver 44. The CPU 40 is an arithmetic unit that realizes the entire function of the driving controller 4 by reading out a program and data from a storage device such as the ROM 41 into the RAM 42 and executing processing.

The ROM 41 is a non-volatile storage device and stores a program for the CPU 40 to execute processing and data such as the optical scanning information described above. The RAM 42 is a volatile storage device that temporarily holds a program and data.

The light source driver 43 is an electric circuit that outputs a drive signal to the light source 3 under the control of the CPU 40. In the light source driver 43, the drive signal is a driving voltage for controlling the irradiation timing and the irradiation intensity of the light source 3.

The MMD driver 44 is an electric circuit that outputs a drive signal to the MMD 2 under the control of the CPU 40. In the MMD driver 44, the drive signal is a driving voltage for controlling the timing, cycle, and deflection angle for allowing the mirror portion 20 of the MMD 2 to swing.

The CPU 40 controls the light source driver 43 and the MMD driver 44 based on the optical scanning information. The optical scanning information is information including the scanning pattern of the light beam LB with which the surface to be scanned 5 is scanned and the light emission timing of the light source 3.

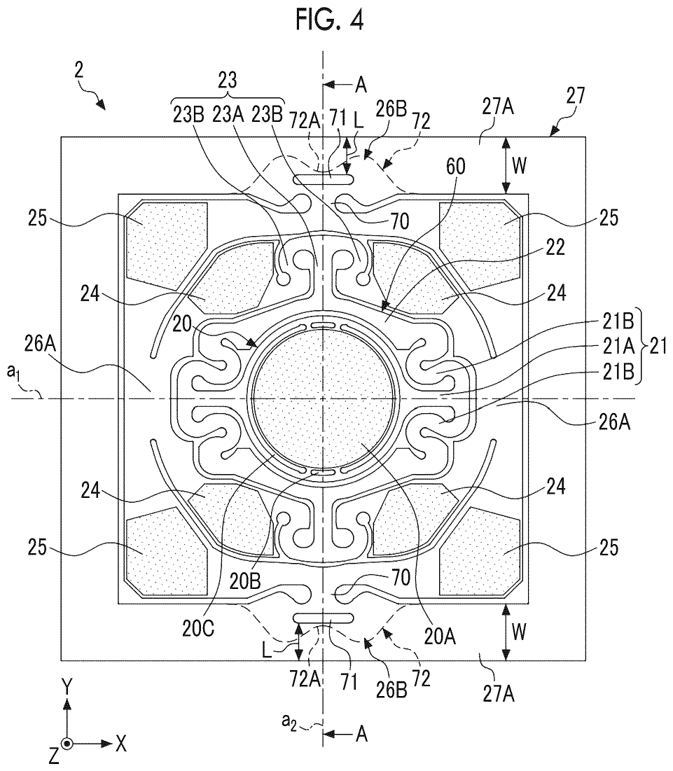

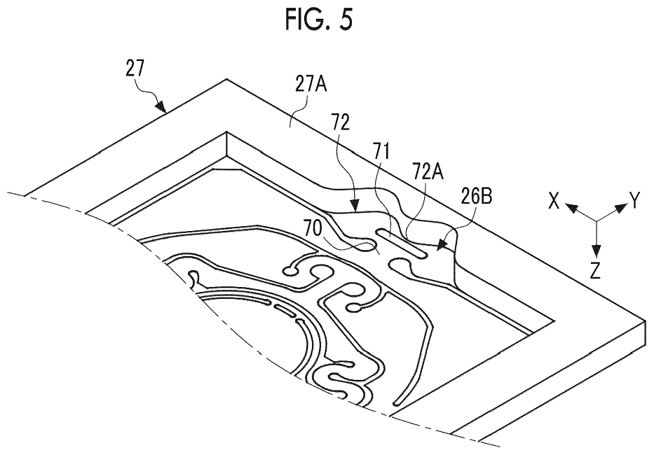

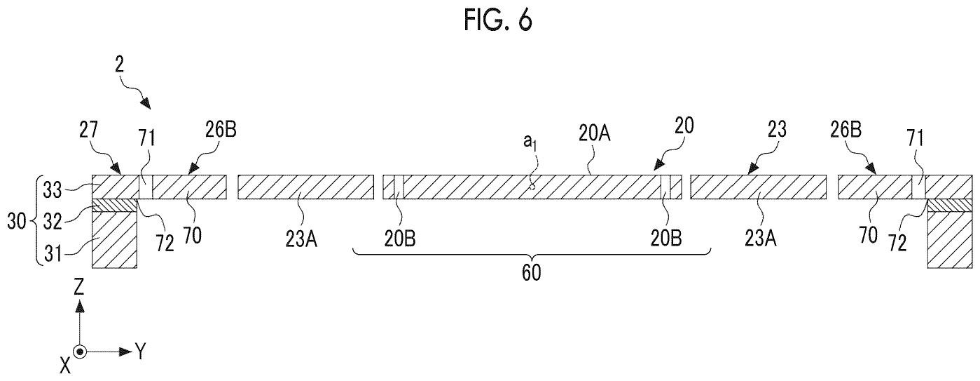

Next, the configuration of the MMD 2 according to a first embodiment will be described with reference to FIGS. 3 to 6. FIG. 3 is an external perspective view of the MMD 2. FIG. 4 is a plan view of the MMD 2 as viewed from the light incident side. FIG. 5 is a perspective view showing a part of the rear surface side of the MMD 2. FIG. 6 is a cross-sectional view taken along a line A-A in FIG. 4.

As shown in FIG. 3, the MMD 2 includes a mirror portion 20, a pair of first support portions 21, a pair of movable frames 22, a pair of second support portions 23, a pair of first actuators 24, a pair of second actuators 25, a pair of actuator connecting portions 26A, a pair of fixed frame connecting portions 26B, and a fixed frame 27. The MMD 2 is a so-called MEMS scanner.

The mirror portion 20 has a reflecting surface 20A for reflecting incident light. The reflecting surface 20A is provided on one surface of the mirror portion 20, and is formed of a metal thin film such as gold (Au) and aluminum (Al). The shape of the reflecting surface 20A is, for example, circular with the intersection of the first axis a₁ and the second axis a₂ as the center.

The first axis a₁ and the second axis a₂ exist, for example, in a plane including the reflecting surface 20A in a case where the mirror portion 20 is stationary. A planar shape of the MMD 2 is a rectangular shape, and is line-symmetric with respect to the first axis a₁ as a symmetry axis and is line-symmetric with respect to the second axis a₂ as a symmetry axis.

The pair of first support portions 21 are disposed at positions facing each other across the second axis a₂, and have a shape that is line-symmetric with respect to the second axis a₂ as a symmetry axis. In addition, each of the first support portions 21 has a shape that is line-symmetric with respect to the first axis a₁ as a symmetry axis. The first support portions 21 are connected to the mirror portion 20 on the first axis a₁, and swingably support the mirror portion 20 around the first axis a₁.

The pair of movable frames 22 are disposed at positions facing each other across the first axis a₁, and have a shape that is line-symmetric with respect to the first axis a₁ as a symmetry axis. Each of the movable frames 22 has a shape that is line-symmetric with respect to the second axis a₂ as a symmetry axis. In addition, each of the movable frames 22 is curved along the outer periphery of the mirror portion 20. Both ends of the movable frame 22 are connected to the first support portion 21.

The first support portion 21 and the movable frame 22 are connected to each other to surround the mirror portion 20. The mirror portion 20, the pair of first support portions 21, and the pair of movable frames 22 constitute a movable portion 60.

The pair of second support portions 23 are disposed at positions facing each other across the first axis a₁, and have a shape that is line-symmetric with respect to the first axis a₁ as a symmetry axis. Each of the second support portions 23 has a shape that is line-symmetric with respect to the second axis a₂ as a symmetry axis. The second support portion 23 is connected to the movable frame 22 on the second axis a₂, and swingably supports the movable portion 60 having the mirror portion 20 around the second axis a₂. In addition, both ends of the second support portion 23 are connected to the first actuator 24.

The pair of first actuators 24 are disposed at positions facing each other across the second axis a₂, and have a shape that is line-symmetric with respect to the second axis a₂ as a symmetry axis. In addition, the first actuator 24 has a shape that is line-symmetric with respect to the first axis a₁ as a symmetry axis. The first actuator 24 is formed along the outer periphery of the movable frame 22 and the first support portion 21. The first actuator 24 is a piezoelectric drive type actuator comprising a piezoelectric element.

Each of the pair of first actuators 24 is electrically connected to each other across the first axis a₁ by a wiring (not shown). The pair of first actuators 24 disposed across the second axis a₂ are electrically separated.

The pair of second support portions 23 and the pair of first actuators 24 are connected to each other to surround the movable portion 60.

The pair of second actuators 25 are disposed at positions facing each other across the first axis a₁, and have a shape that is line-symmetric with respect to the first axis a₁ as a symmetry axis. In addition, the second actuator 25 has a shape that is line-symmetric with respect to the second axis a₂ as a symmetry axis. The second actuator 25 is formed along the outer periphery of the first actuator 24 and the second support portion 23. The second actuator 25 is a piezoelectric drive type actuator comprising a piezoelectric element.

Each of the pair of second actuators 25 is electrically connected to each other across the second axis a₂ by a wiring (not shown). The pair of second actuators 25 disposed across the first axis a₁ are electrically separated.

The pair of actuator connecting portions 26A are disposed at positions facing each other across the second axis a₂, and have a shape that is line-symmetric with respect to the second axis a₂ as a symmetry axis. In addition, each of the actuator connecting portions 26A has a shape that is line-symmetric with respect to the first axis a₁ as a symmetry axis. The actuator connecting portion 26A is disposed along the first axis a₁, and the first actuator 24 and the second actuator 25 are connected to each other on the first axis a₁.

The pair of fixed frame connecting portions 26B are disposed on the second axis a₂ at positions facing each other across the first axis a₁. In addition, the pair of fixed frame connecting portions 26B have a shape that is line-symmetric with respect to the first axis a₁ as a symmetry axis. In addition, each of the pair of fixed frame connecting portions 26B have a shape that is line-symmetric with respect to the second axis a₂ as a symmetry axis. The fixed frame connecting portion 26B connects the second actuator 25 and the fixed frame 27 to each other on the second axis a₂ via the end part 70. The end portion 70 is a portion having the narrowest width in the fixed frame connecting portion 26B. The fixed frame connecting portion 26B swingably supports the second actuator 25 around the second axis a₂. The fixed frame connecting portion 26B is an example of a “connecting portion” according to the technology of the present disclosure.

In addition, each of the pair of fixed frame connecting portions 26B has a slit 71. The slit 71 is disposed on the second axis a₂ and has a shape that is line-symmetric with respect to the second axis a₂ as a symmetry axis. The slit 71 extends in the X direction. The length of the slit 71 in the X direction is longer than the length of the end part 70 in the X direction. The slit 71 is disposed in the vicinity of a boundary (hereinafter, referred to as a connection boundary) 72 between the fixed frame connecting portion 26B and the fixed frame 27. In the present embodiment, the connection boundary 72 has a protruding portion 72A of which a part protrudes to the slit 71 side. The protruding portion 72A is closest to the slit 71 on the second axis a₂.

The pair of second actuators 25 surround the pair of first actuators 24. The pair of first actuators 24 and the pair of second actuators 25 constitute a driving unit disposed to surround the pair of movable frames 22.

The fixed frame 27 is a frame-shaped member having a rectangular outer shape, and has a shape that is line-symmetric with respect to the first axis a₁ and the second axis a₂ as a symmetry axis, respectively. The fixed frame 27 surrounds the outer periphery of the pair of second actuators 25 and the fixed frame connecting portions 26B. That is, the fixed frame 27 surrounds the driving unit.

The fixed frame 27 includes a pair of beam portions 27A. The pair of beam portions 27A are in contact with the pair of fixed frame connecting portions 26B and extend in the first direction. In the present embodiment, the first direction is a direction parallel to the first axis a₁. In addition, the maximum value W of the widths of the pair of beam portions 27A in the second direction is larger than the distance L from the outermost end of the fixed frame 27 in the second direction to the slit 71. In the present embodiment, the second direction is a direction parallel to the second axis a₂.

The first actuator 24 and the second actuator 25 are piezoelectric actuators each including a piezoelectric element. The pair of first actuators 24 allow the movable portion 60 to swing around the second axis a₂ by applying rotational torque around the second axis a₂ to the mirror portion 20 and the movable frame 22. The pair of second actuators 25 allow the mirror portion 20 to swing around the first axis a₁ by applying rotational torque around the first axis a₁ to the mirror portion 20, the movable frame 22, and the first actuator 24.

As shown in FIG. 4, the first support portion 21 is composed of a swing shaft 21A and a pair of coupling portions 21B. The swing shaft 21A is a so-called torsion bar stretched along the first axis a₁. One end of the swing shaft 21A is connected to the mirror portion 20, and the other end of the swing shaft 21A is connected to the coupling part 21B.

The pair of coupling parts 21B are disposed at positions facing each other across the first axis a₁, and have a shape that is line-symmetric with respect to the first axis a₁ as a symmetry axis. One end of the coupling part 21B is connected to an outer end portion of the swing shaft 21A on the first axis a₁, and the other end of the coupling part 21B is connected to the movable frame 22. The coupling portion 21B has a folded structure. Specifically, the connecting portion 21B extends in a direction from the outer end portion of the swing shaft 21A on the first axis a₁ toward the mirror portion 20, is bent in the outer circumferential direction in a region adjacent to the mirror portion 20, and is bent again in a region adjacent to the first actuator 24 to be connected to the movable frame 22. As described above, since the coupling part 21B has elasticity due to the folded structure, the internal stress applied to the swing shaft 21A is relaxed in a case where the mirror portion 20 swings around the first axis a₁.

The second support portion 23 is composed of a swing shaft 23A and a pair of coupling portions 23B. The swing shaft 23A is a so-called torsion bar extended along the second axis a₂. One end of the swing shaft 23A is connected to the movable frame 22, and the other end thereof is connected to the coupling portion 23B.

The pair of coupling parts 23B are disposed at positions facing each other across the second axis a₂, and have a shape that is line-symmetric with respect to the second axis a₂ as a symmetry axis. One end of the coupling part 23B is connected to an outer end portion of the swing shaft 23A on the second axis a₂, and the other end of the coupling part 23B is connected to the first actuator 24. The coupling part 23B has a folded structure. Specifically, the connecting portion 23B extends from the outer end portion on the second axis a₂ of the swing shaft 23A in a direction toward the mirror portion 20 and is connected to the first actuator 24 in a region adjacent to the movable frame 22. As described above, since the coupling part 23B has elasticity due to the folded structure, the internal stress applied to the swing shaft 23A is relaxed in a case where the mirror portion 20 swings around the second axis a₂.

In the mirror portion 20, a plurality of slits 20B and 20C are formed on the outside of the reflecting surface 20A along the outer periphery of the reflecting surface 20A. The plurality of slits 20B and 20C are disposed at positions that are line-symmetric with the first axis a₁ and the second axis a₂ as a symmetry axis, respectively. The slit 20B has an effect of suppressing distortion generated on the reflecting surface 20A due to the swing of the mirror portion 20.

In FIGS. 3 and 4, wiring lines and electrode pads for applying drive signals to the pair of first actuators 24 and the pair of second actuators 25 are not shown. A plurality of the electrode pads are provided on the fixed frame 27.

As shown in FIG. 6, the MMD 2 is formed, for example, by performing an etching treatment on a silicon on insulator (SOI) substrate 30. The SOI substrate 30 is a substrate in which a silicon oxide layer 32 is provided on a first silicon active layer 31 made of single crystal silicon, and a second silicon active layer 33 made of single crystal silicon is provided on the silicon oxide layer 32. The first silicon active layer 31, the silicon oxide layer 32, and the second silicon active layer 33 are respectively referred to as a handle layer, a box layer, and a device layer.

The mirror portion 20, the first support portion 21, the movable frame 22, the second support portion 23, the first actuator 24, the second actuator 25, the actuator connecting portion 26A, and the fixed frame connecting portion 26B are formed of the second silicon active layer 33 remaining by removing the first silicon active layer 31 and the silicon oxide layer 32 from the SOI substrate 30 by an etching treatment. The second silicon active layer 33 functions as an elastic portion having elasticity.

The fixed frame 27 is formed of three layers of the first silicon active layer 31, the silicon oxide layer 32, and the second silicon active layer 33. That is, the mirror portion 20, the first support portion 21, the movable frame 22, the second support portion 23, the first actuator 24, the second actuator 25, the actuator connecting portion 26A, and the fixed frame connecting portion 26B are thinner than the fixed frame 27, respectively. In the present disclosure, the thickness means a width in the Z direction.

In each of the fixed frame connecting portions 26B, the bottom surface of the fixed frame connecting portion 26B and the side surface of the fixed frame 27 intersect each other at an angle of about 90° at the connection boundary 72. The slit 71 is a groove that penetrates the second silicon active layer 33 and is provided to be close to the connection boundary 72.

The first actuator 24 includes a piezoelectric element (not shown) formed on the second silicon active layer 33. The piezoelectric element has a laminated structure in which a lower electrode, a piezoelectric film, and an upper electrode are sequentially laminated on the second silicon active layer 33. The second actuator 25 has the same configuration as the first actuator 24.

The lower electrode and the upper electrode are formed of, for example, metal such as gold (Au) or platinum (Pt). The piezoelectric film is formed of, for example, lead zirconate titanate (PZT), which is a piezoelectric material. The lower electrode and the upper electrode are electrically connected to the driving controller 4 described above via the wiring line and the electrode pad.

The lower electrode is connected to the driving controller 4 via the wiring line and the electrode pad, and a ground potential is applied thereto. A driving voltage is applied to the upper electrode from the driving controller 4.

In a case where a positive or negative voltage is applied to the piezoelectric film in the polarization direction, deformation (for example, expansion and contraction) proportional to the applied voltage occurs. That is, the piezoelectric film exerts a so-called inverse piezoelectric effect. The piezoelectric film exerts an inverse piezoelectric effect by applying a driving voltage from the driving controller 4 to the upper electrode, and displaces the first actuator 24 and the second actuator 25.

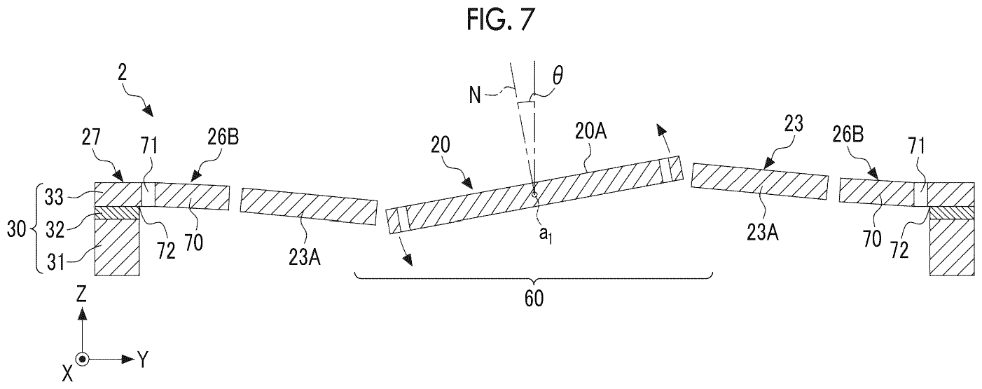

FIG. 7 shows an example in which one piezoelectric film of the pair of second actuators 25 is extended and the other piezoelectric film is contracted, thereby generating rotational torque around the first axis a₁ in the pair of second actuators 25. In this way, one of the pair of second actuators 25 and the other are displaced in opposite directions to each other, whereby the mirror portion 20 rotates around the first axis a₁.

In addition, FIG. 7 shows an example in which the second actuator 25 is driven in an anti-phase resonance mode (hereinafter, referred to as an anti-phase rotation mode) in which the displacement direction of the pair of second actuators 25 and the rotation direction of the mirror portion 20 are opposite to each other. On the other hand, an in-phase resonance mode in which the displacement direction of the pair of second actuators 25 and the rotation direction of the mirror portion 20 are in the same direction is called an in-phase rotation mode. In the present embodiment, the second actuator 25 is driven in the anti-phase rotation mode.

A deflection angle θ of the mirror portion 20 around the first axis a₁ is controlled by the drive signal (hereinafter, referred to as a first drive signal) given to the second actuator 25 by the driving controller 4. The first drive signal is, for example, a sinusoidal AC voltage. The first drive signal includes a driving voltage waveform V_{1A} (t) applied to one of the pair of second actuators 25 and a driving voltage waveform V_{1B} (t) applied to the other. The driving voltage waveform V_{1A} (t) and the driving voltage waveform V_{1B} (t) are in an anti-phase with each other (that is, the phase difference is 180°).

The deflection angle θ of the mirror portion 20 around the first axis a₁ corresponds to an angle at which the normal line N of the reflecting surface 20A is inclined with respect to the Z direction in the YZ plane.

The first actuator 24 is driven in the anti-phase rotation mode similarly to the second actuator 25. A deflection angle of the mirror portion 20 around the second axis a₂ is controlled by the drive signal (hereinafter, referred to as a second drive signal) given to the first actuator 24 by the driving controller 4. The second drive signal is, for example, a sinusoidal AC voltage. The second drive signal includes a driving voltage waveform V_{2A} (t) applied to one of the pair of first actuators 24 and a driving voltage waveform V_{2B} (t) applied to the other. The driving voltage waveform V_{2A} (t) and the driving voltage waveform V_{2B} (t) are in an anti-phase with each other (that is, the phase difference is 180°).

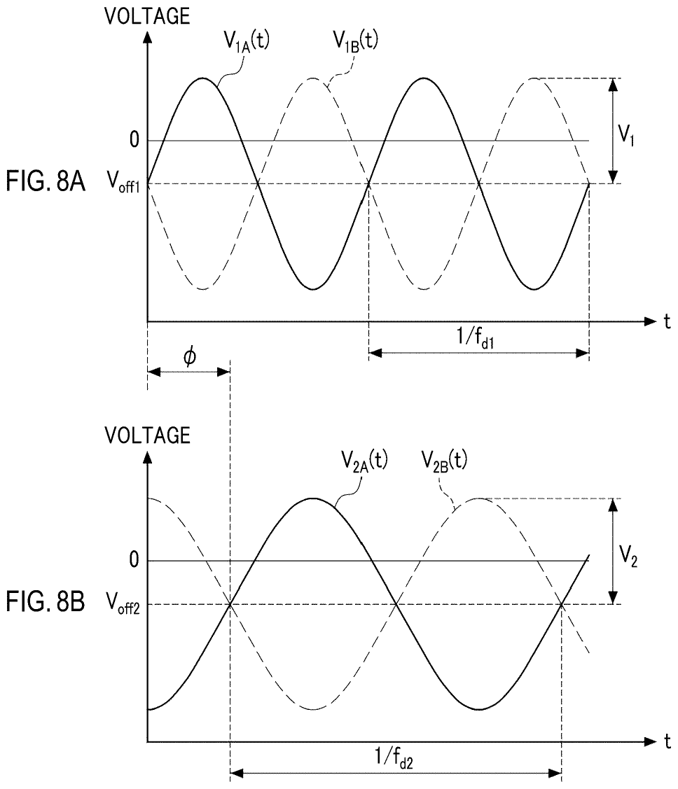

FIGS. 8A and 8B show examples of the first drive signal and the second drive signal. FIG. 8A shows the driving voltage waveforms V_{1A} (t) and V_{1B} (t) included in the first drive signal. FIG. 8B shows the driving voltage waveforms V_{2A} (t) and V_{2B} (t) included in the second drive signal.

The driving voltage waveforms V_{1A} (t) and V_{1B} (t) are represented as follows, respectively.

$${V}_{1 A} ( t ) = {V}_{off 1} + {V}_{1} sin ( 2 π {f}_{d 1} t )$$

$${V}_{1 B} ( t ) = {V}_{off 1} + {V}_{1} sin ( 2 π {f}_{d 1} t + α )$$

Here, V₁ is the amplitude voltage. V_{off1} is the bias voltage. f_{d1} is the driving frequency (hereinafter, referred to as the first driving frequency). t is time. α is the phase difference between the driving voltage waveforms V_{1A} (t) and V_{1B} (t). In the present embodiment, for example, α=180°.

By applying the driving voltage waveforms V_{1A} (t) and V_{1B} (t) to the pair of second actuators 25, the mirror portion 20 swings around the first axis a₁ at the first driving frequency f_{d1}.

The driving voltage waveforms V_{2A} (t) and V_{2B} (t) are represented as follows, respectively.

$${V}_{2 A} ( t ) = {V}_{off 2} + {V}_{2} sin ( 2 π {f}_{d 2} t + φ )$$

$${V}_{2 B} ( t ) = {V}_{off 2} + {V}_{2} sin ( 2 π {f}_{d 2} t + β + φ )$$

Here, V₂ is the amplitude voltage. V_{off2} is the bias voltage. f_{d2} is the driving frequency (hereinafter, referred to as the second driving frequency). t is time. β is the phase difference between the driving voltage waveforms V_{2A} (t) and V_{2B} (t). In the present embodiment, for example, β=180°. In addition, φ is the phase difference between the driving voltage waveforms V_{1A} (t) and V_{1B} (t) and the driving voltage waveforms V_{2A} (t) and V_{2B} (t). In the present embodiment, for example, V_{off1}=V_{off2}=0 V.

By applying the driving voltage waveforms V_{2A} (t) and V_{2B} (t) to the pair of first actuators 24, the movable portion 60 including the mirror portion 20 swings around the second axis a₂ at the second driving frequency f_{d2}.

The first driving frequency f_{d1} is set so as to match the resonance frequency around the first axis a₁ of the mirror portion 20. The second driving frequency f_{d2} is set so as to match the resonance frequency around the second axis a₂ of the mirror portion 20. For example, the first driving frequency f_{d1} is larger than the second driving frequency f_{d2}.

The applicant has found that, by configuring the MMD 2 as described above, it is possible to suppress structural destruction during driving and realize a large deflection angle. Specifically, in the MMD 2, since the thicknesses of the fixed frame connecting portion 26B and the fixed frame 27 are different and a level difference is present at the connection boundary 72, stress concentration occurs in the vicinity of the connection boundary 72 in a case where the deflection angle of the mirror portion 20 is large. In the present embodiment, since the slit 71 is provided in the fixed frame connecting portion 26B, the bending displacement between the fixed frame connecting portion 26B and the fixed frame 27 is suppressed, and the stress concentration in the vicinity of the connection boundary 72 is relaxed. As a result, since the structural destruction during driving is suppressed, a large deflection angle can be realized without increasing the size of the MMD 2.

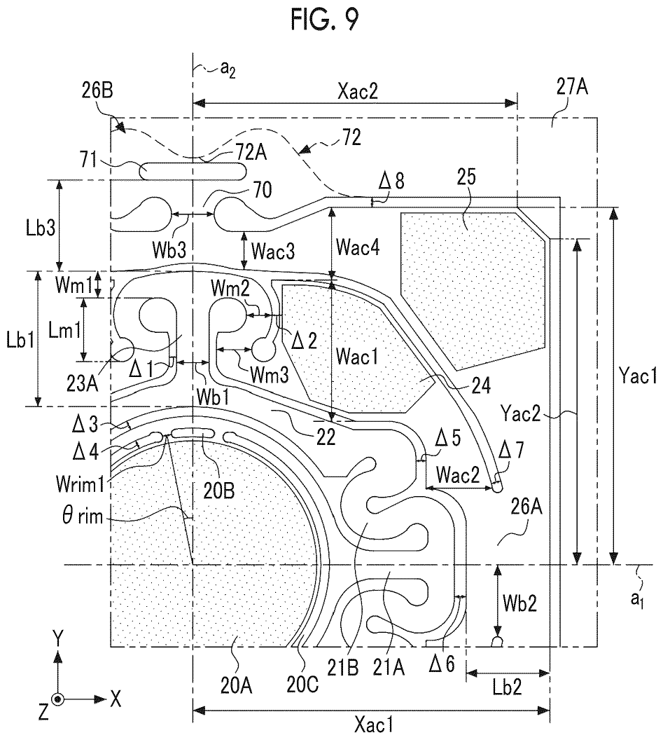

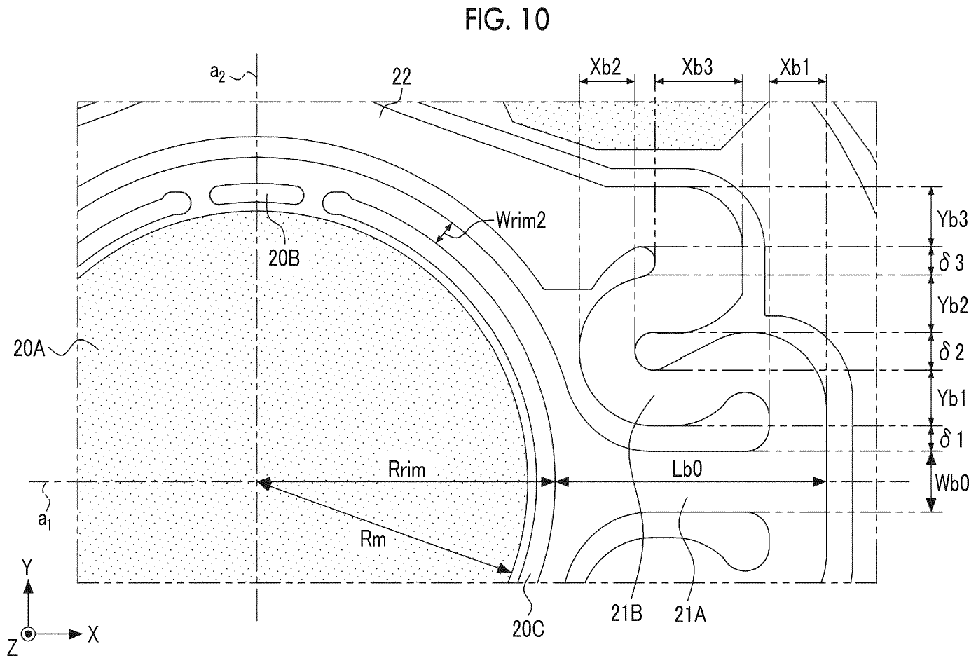

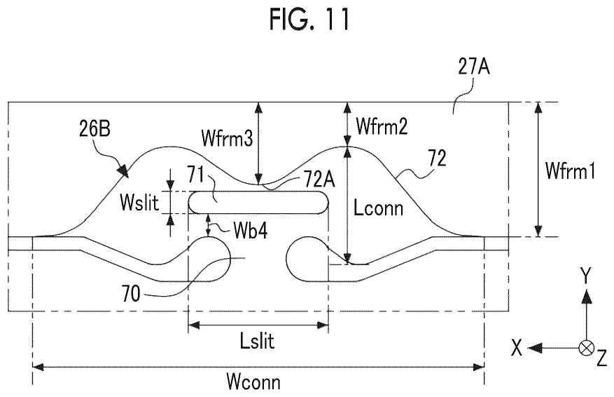

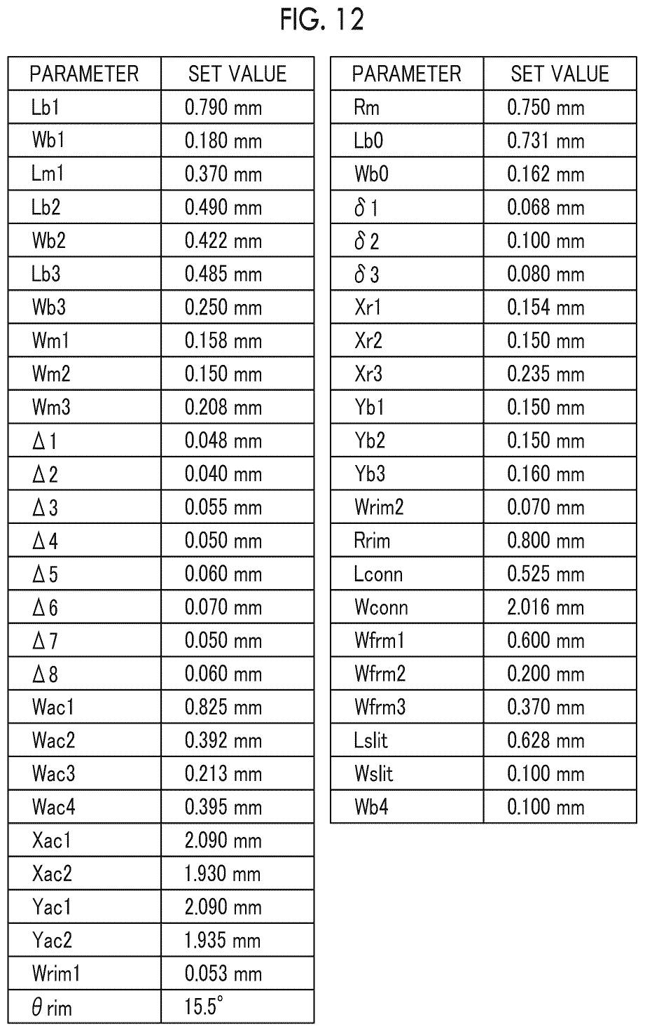

In order to verify the above-described effect, the present applicant performed a resonance mode analysis simulation of the MMD 2 by a finite element method. FIGS. 9 to 11 show parameters related to the width, the length, and the like of each constituent element of the MMD 2 used in the present simulation. FIG. 12 is a diagram showing specific set values of the parameters.

In addition, the diameter of the mirror portion 20 was set to 1.5 mm, the thickness of the SOI substrate 30 was set to 430 μm, and the thickness of the second silicon active layer 33 was set to 100 μm. The length of one side of the fixed frame 27 was 5.5 mm.

In the present simulation, the Mises stress applied to the connection boundary 72 was calculated in a case where the mirror portion 20 was resonantly driven in the anti-phase rotation mode around the first axis a₁ (hereinafter, referred to as first resonance driving) and a case where the mirror portion 20 was resonantly driven in the anti-phase rotation mode around the second axis a₂ (hereinafter, referred to as second resonance driving). Here, θ=17.5° was set (that is, an optical full angle of 70°).

As a result of the present simulation, the calculated value of the Mises stress applied to the connection boundary 72 in the first resonance driving was 134 MPa, and the calculated value of the Mises stress applied to the connection boundary 72 in the second resonance driving was 122 MPa.

### Second Embodiment

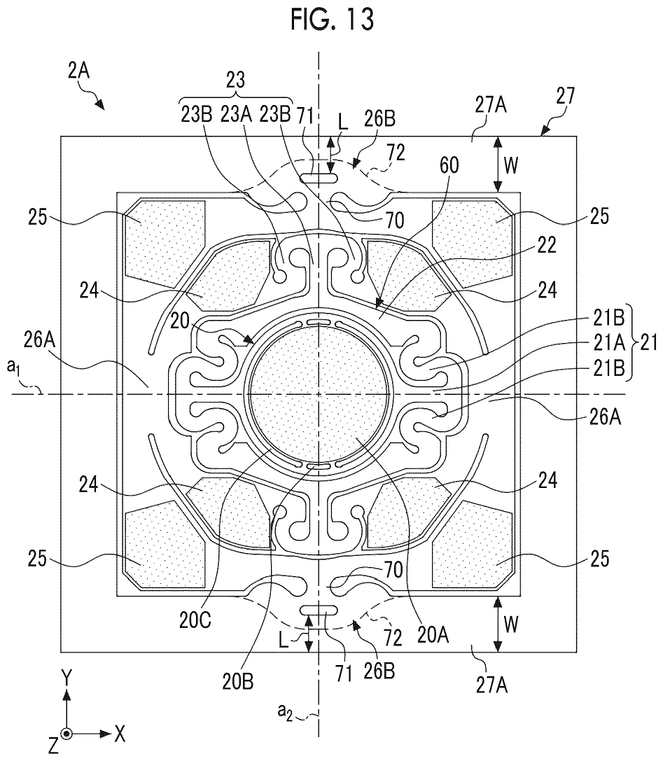

Next, a second embodiment will be described. FIG. 13 is a plan view of the MMD 2A according to the second embodiment as viewed from the light incident side. The MMD 2A is different from the MMD 2 according to the first embodiment only in the configuration of the fixed frame connecting portion 26B. In the present embodiment, the connection boundary 72 does not have the protruding portion 72A and intersects the second axis a₂ to be orthogonal to the second axis a₂. Other configurations of the fixed frame connecting portion 26B according to the present embodiment are the same as the configurations of the fixed frame connecting portion 26B according to the first embodiment.

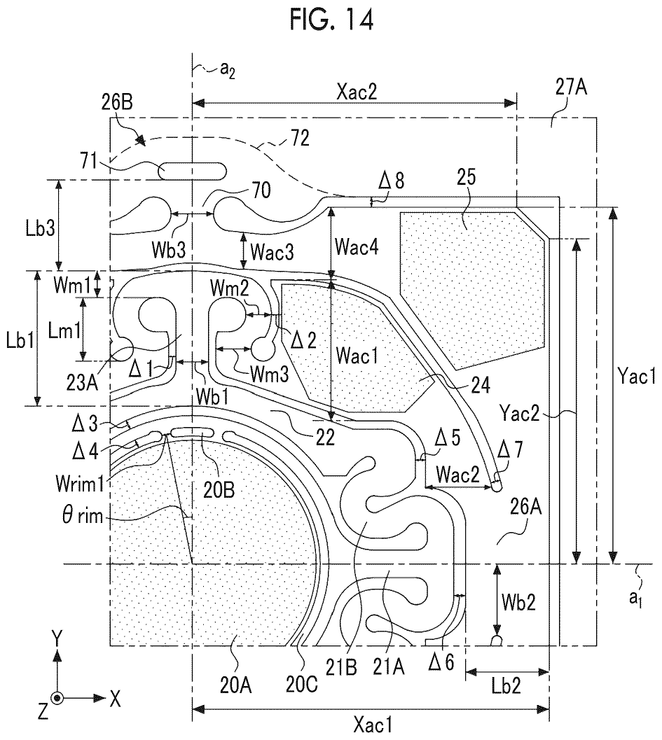

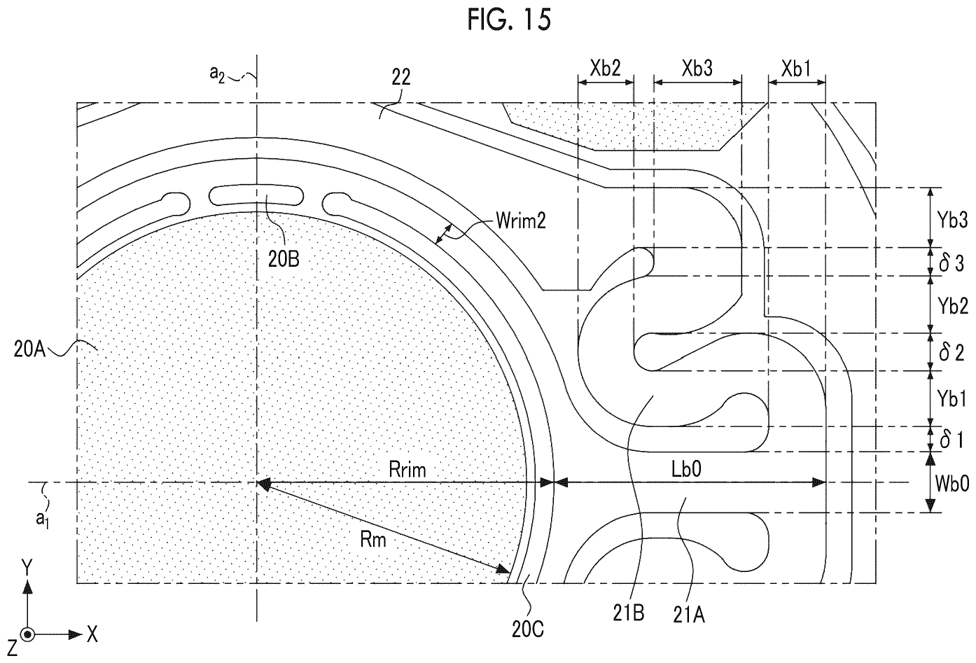

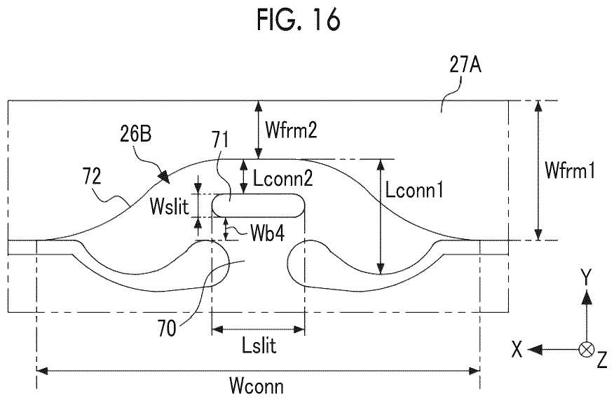

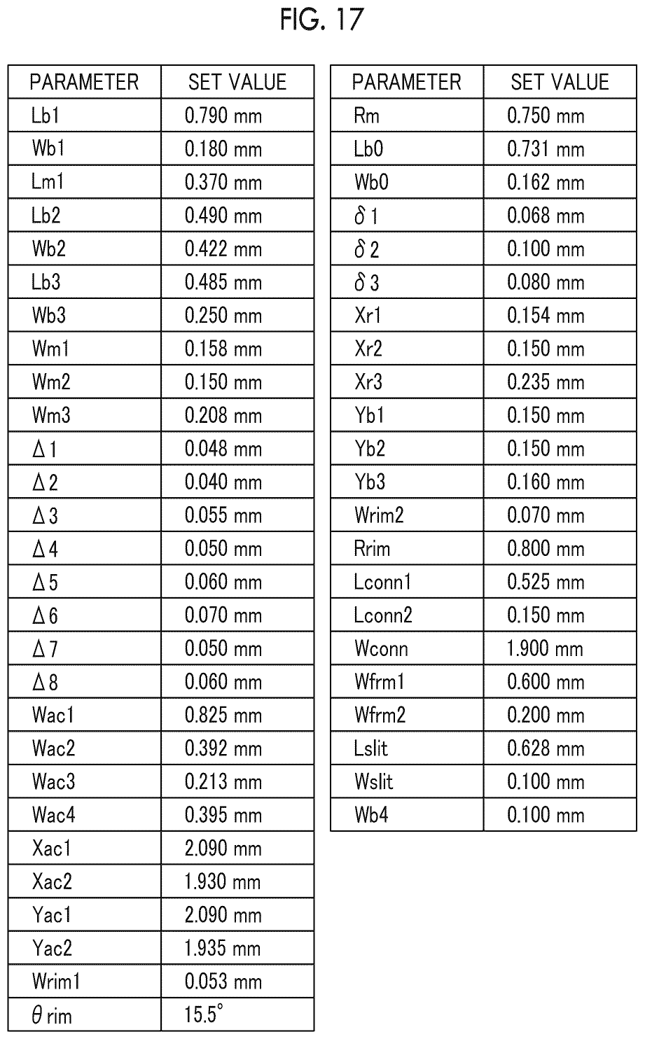

The present applicant also performed the same simulation as described above on the MMD 2A according to the second embodiment. FIGS. 14 to 16 show parameters related to the width, the length, and the like of each component of the MMD 2A used in the present simulation. FIG. 17 is a diagram showing specific set values of the parameters.

As a result of the present simulation, in the present embodiment, the calculated value of the Mises stress applied to the connection boundary 72 in the first resonance driving was 145 MPa, and the calculated value of the Mises stress applied to the connection boundary 72 in the second resonance driving was 151 MPa.

### Third Embodiment

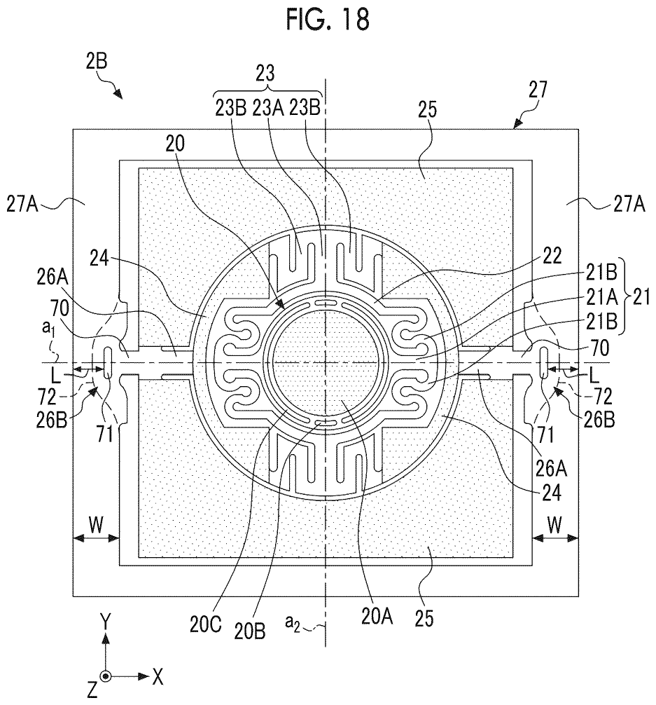

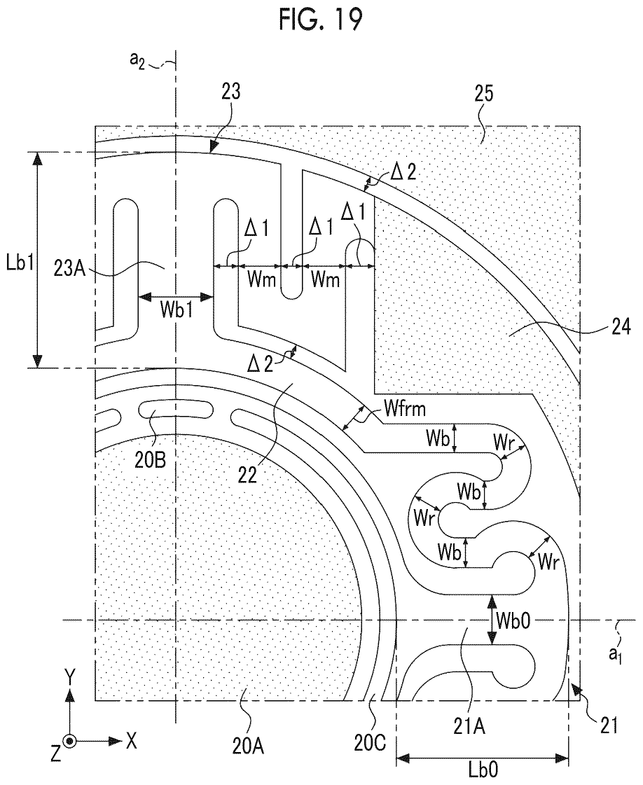

Next, a third embodiment will be described. FIG. 18 is a plan view of the MMD 2B according to the third embodiment as viewed from the light incident side. The MMD 2B is different from the MMD 2 according to the first embodiment in the position and the configuration of the fixed frame connecting portion 26B. In the present embodiment, the fixed frame connecting portion 26B is disposed on the first axis a₁ and has a shape that is line-symmetric with respect to the first axis a₁ as a symmetry axis. The slit 71 extends in the Y direction. The length of the slit 71 in the Y direction is longer than the length of the end part 70 in the Y direction. In addition, in the present embodiment, the fixed frame connecting portion 26B does not have the protruding portion 72A and intersects the first axis a₁ to be orthogonal to the first axis a₁.

The MMD 2B has the same configuration as the MMD 2 according to the first embodiment except that the position and the configuration of the fixed frame connecting portion 26B are different as described above and the shapes of the first actuator 24, the second actuator 25, and the like are different.

The fixed frame 27 includes a pair of beam portions 27A. The pair of beam portions 27A are in contact with the pair of fixed frame connecting portions 26B and extend in the first direction. In the present embodiment, the first direction is a direction parallel to the second axis a₂. In addition, the maximum value W of the widths of the pair of beam portions 27A in the second direction is larger than the distance L from the outermost end of the fixed frame 27 in the second direction to the slit 71. In the present embodiment, the second direction is a direction parallel to the first axis a₁.

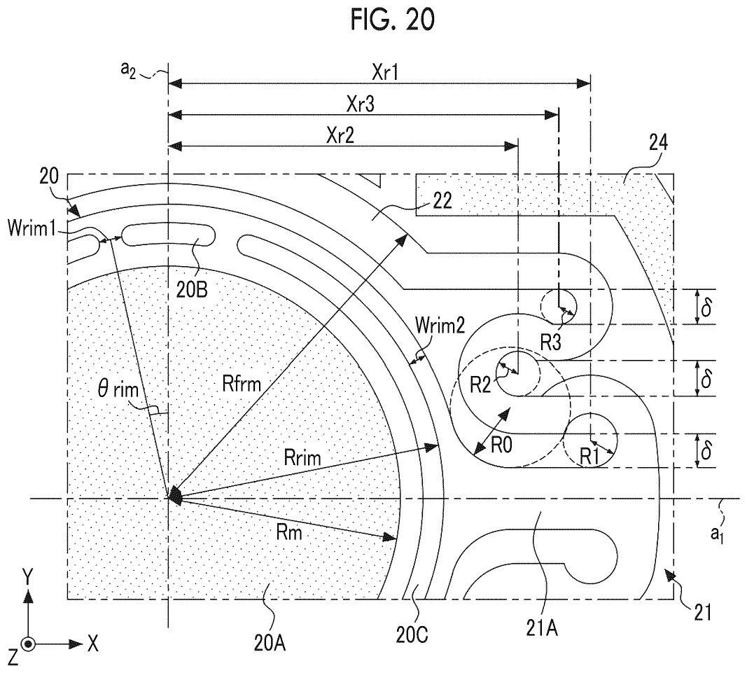

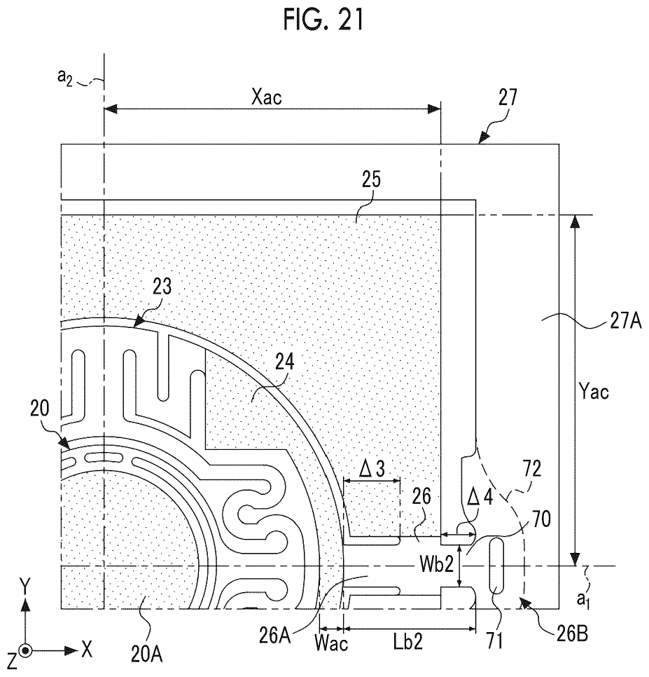

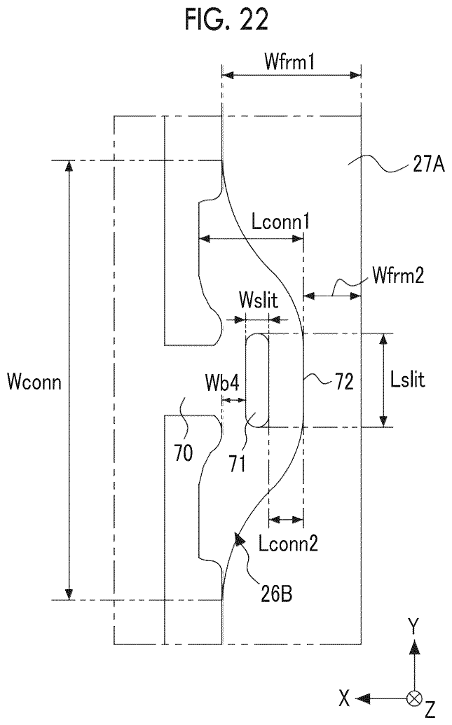

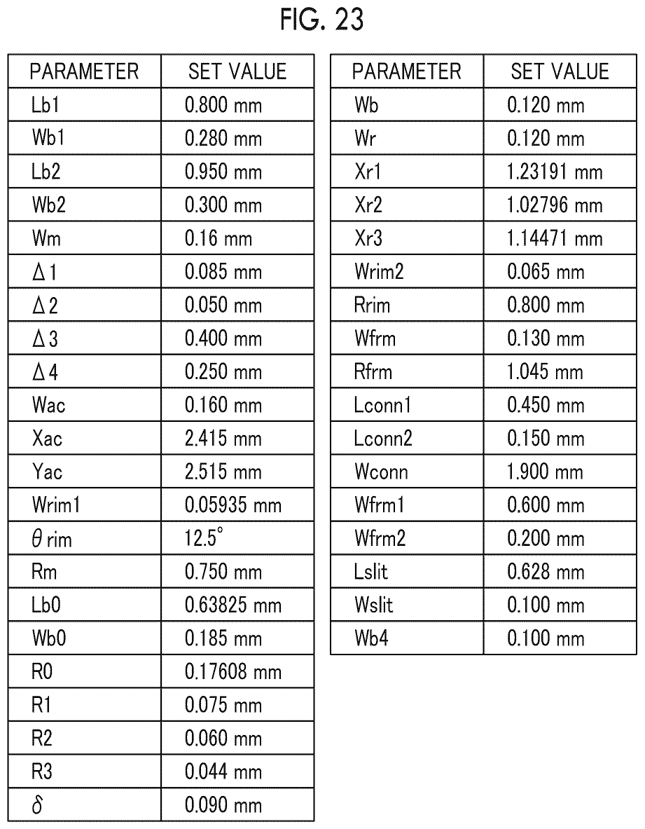

The present applicant also performed the same simulation as described above on the MMD 2B according to the third embodiment. FIGS. 19 to 22 show parameters related to the width, the length, and the like of each component of the MMD 2B used in the simulation. FIG. 23 is a diagram showing specific set values of the parameters.

As a result of the present simulation, in the present embodiment, the calculated value of the Mises stress applied to the connection boundary 72 in the first resonance driving was 40 MPa, and the calculated value of the Mises stress applied to the connection boundary 72 in the second resonance driving was 125 MPa.

In the present embodiment, the connection boundary 72 does not have the protruding portion 72A, but the protruding portion 72A may be provided in the connection boundary 72 as in the first embodiment.

### First Comparative Example

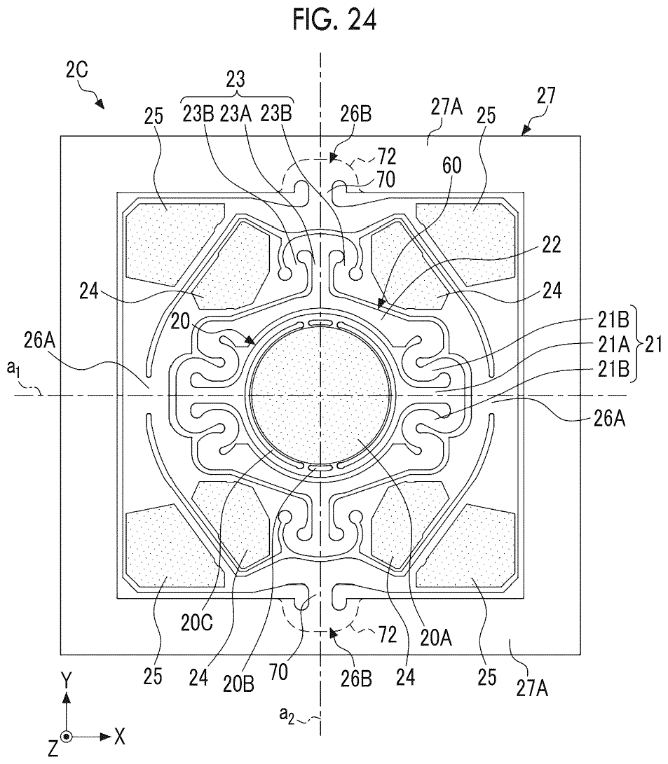

Next, the first comparative example will be described. FIG. 24 is a plan view of the MMD 2C according to the first comparative example as viewed from the light incident side. The MMD 2C is different from the MMD 2 according to the first embodiment only in the configuration of the fixed frame connecting portion 26B. In the present comparative example, the slit 71 is not formed in the fixed frame connecting portion 26B. In addition, the connection boundary 72 does not have the protruding portion 72A and intersects the second axis a₂ to be orthogonal to the second axis a₂. Other configurations of the fixed frame connecting portion 26B according to the present comparative example are the same as the configurations of the fixed frame connecting portion 26B according to the first embodiment.

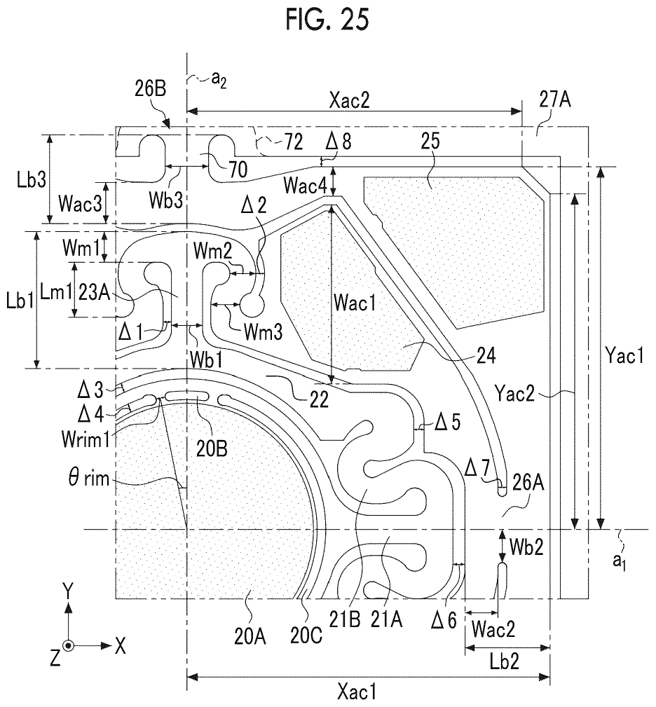

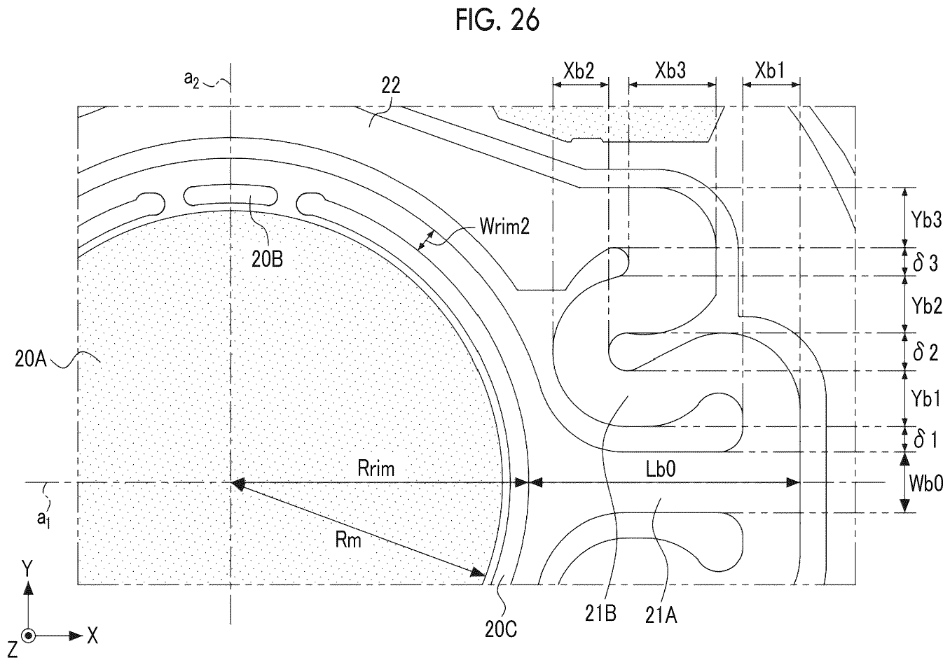

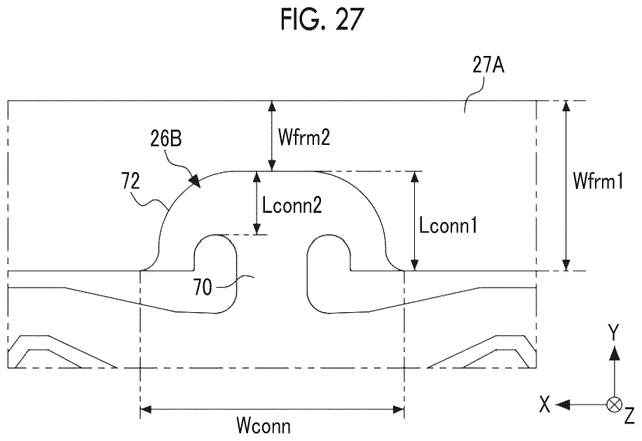

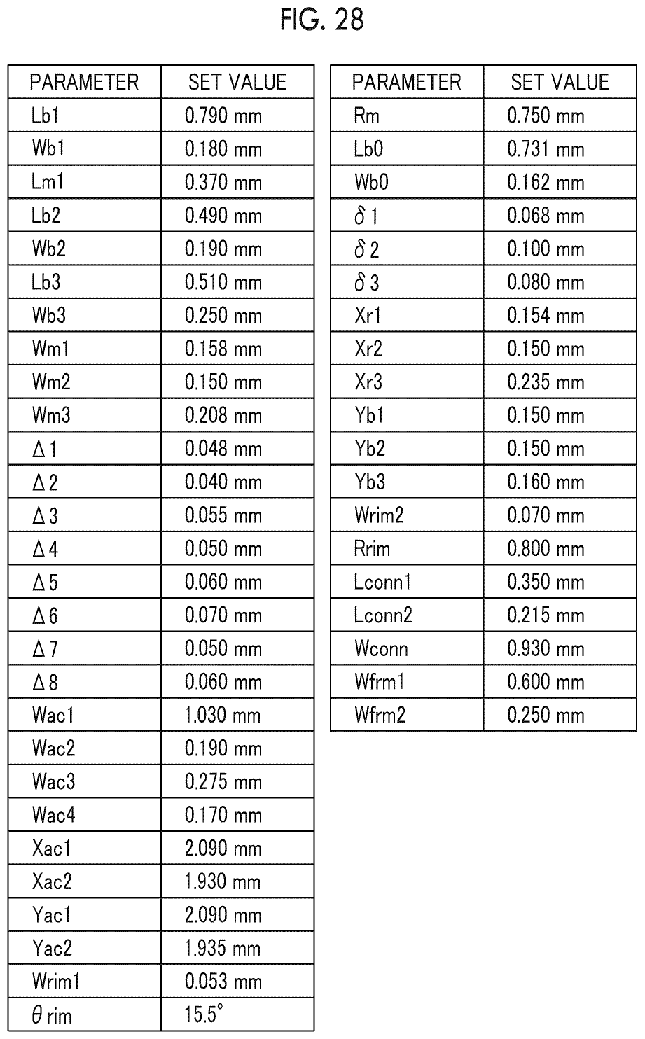

The present applicant also performed the same simulation as described above on the MMD 2C according to the first comparative example. FIGS. 25 to 27 show parameters related to the width, the length, and the like of each component of the MMD 2C used in the present simulation. FIG. 28 is a diagram showing specific set values of the parameters.

As a result of the present simulation, in the present comparative example, the calculated value of the Mises stress applied to the connection boundary 72 in the first resonance driving was 209 MPa, and the calculated value of the Mises stress applied to the connection boundary 72 in the second resonance driving was 151 MPa.

### Second Comparative Example

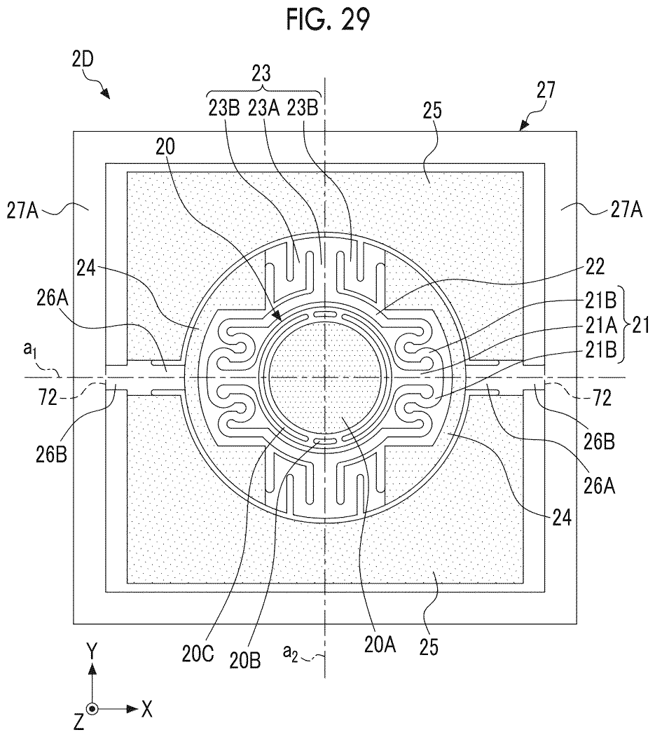

Next, the second comparative example will be described. FIG. 29 is a plan view of the MMD 2D according to the second comparative example as viewed from the light incident side. The MMD 2D is different from the MMD 2B according to the third embodiment only in the configuration of the fixed frame connecting portion 26B. In the present comparative example, the slit 71 is not formed in the fixed frame connecting portion 26B. In addition, the connection boundary 72 does not have the protruding portion 72A and intersects the first axis a₁ to be orthogonal to the first axis a₁.

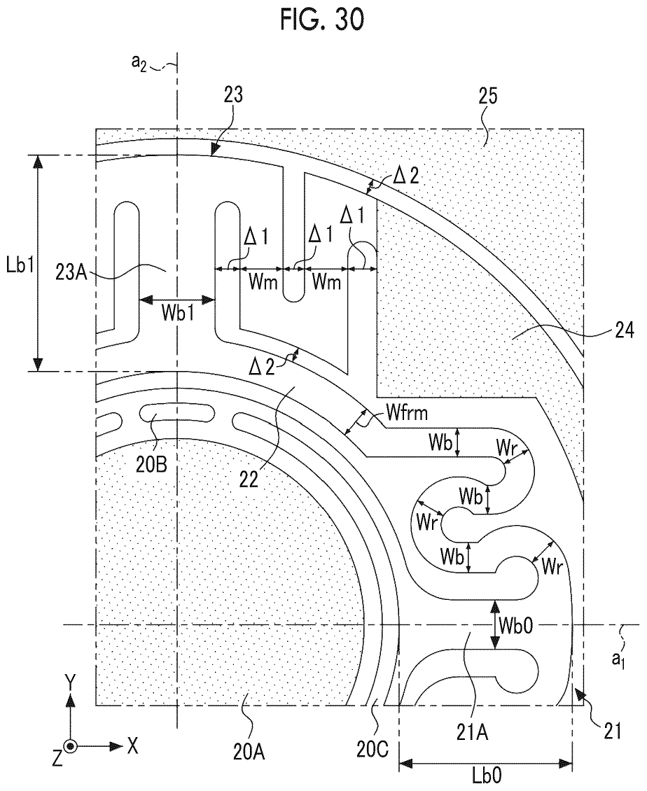

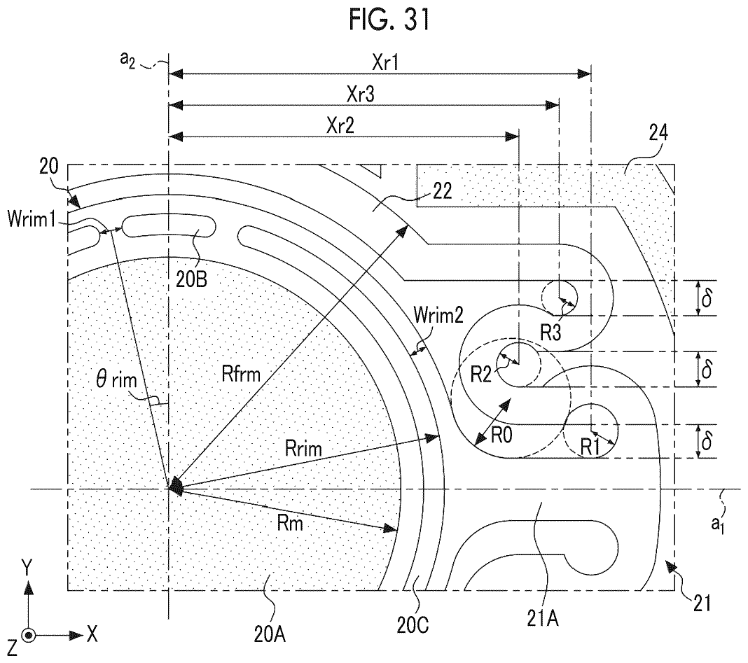

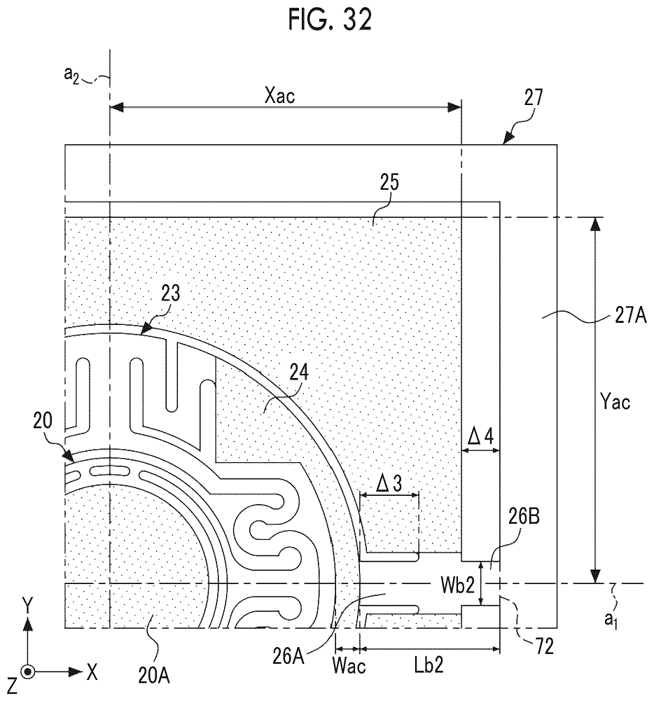

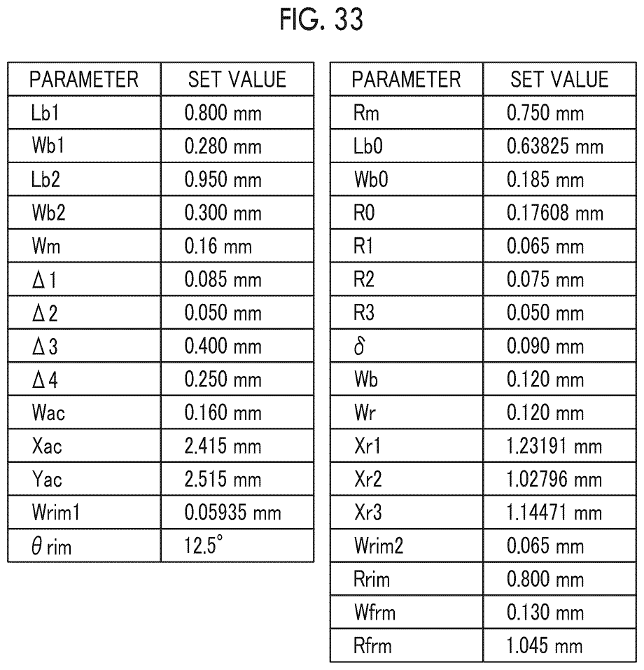

The present applicant also performed the same simulation as described above on the MMD 2D according to the second comparative example. FIGS. 30 to 32 show parameters related to the width, the length, and the like of each constituent element of the MMD 2D used in the present simulation. FIG. 33 is a diagram showing specific set values of the parameters.

As a result of the present simulation, in the present comparative example, the calculated value of the Mises stress applied to the connection boundary 72 in the first resonance driving was 198 MPa, and the calculated value of the Mises stress applied to the connection boundary 72 in the second resonance driving was 317 MPa.

### CONCLUSION

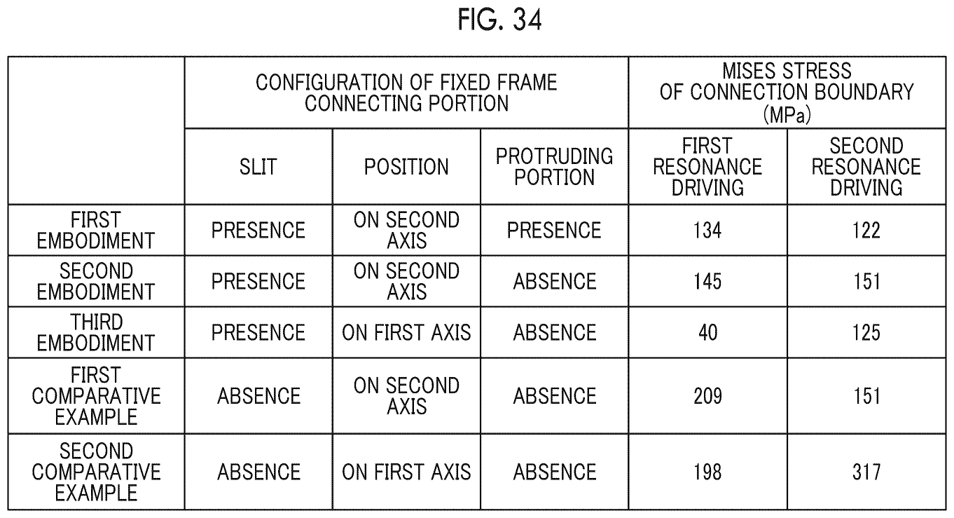

FIG. 34 shows simulation results according to each of the embodiments and each of the comparative examples described above. It can be seen that in the first to third embodiments in which the slits 71 are formed in the fixed frame connecting portion 26B, the stress applied to the connection boundary 72 is reduced as compared with the first and second comparative examples in which the slits 71 are not formed.

In general, in the MMD, the performance of the optical full angle of 70° is a performance that can sufficiently expand the use of the MMD, and for example, in a laser scanning display, it enables an angle of view corresponding to 4K image quality. In addition, in the SOI substrate, in a case where the Mises stress applied to the connection boundary 72 exceeds 300 MPa, there is a tendency that sudden structural destruction is likely to occur in a case where the stress applied to the connection boundary 72 exceeds 300 MPa in a case where the mirror portion 20 is continuously driven. Therefore, the technology of the present disclosure significantly improves the performance of the MMD.

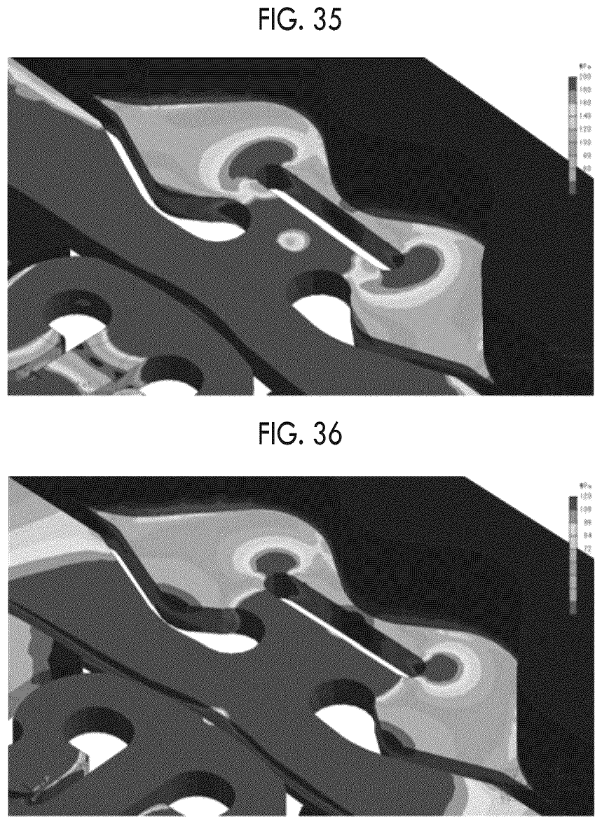

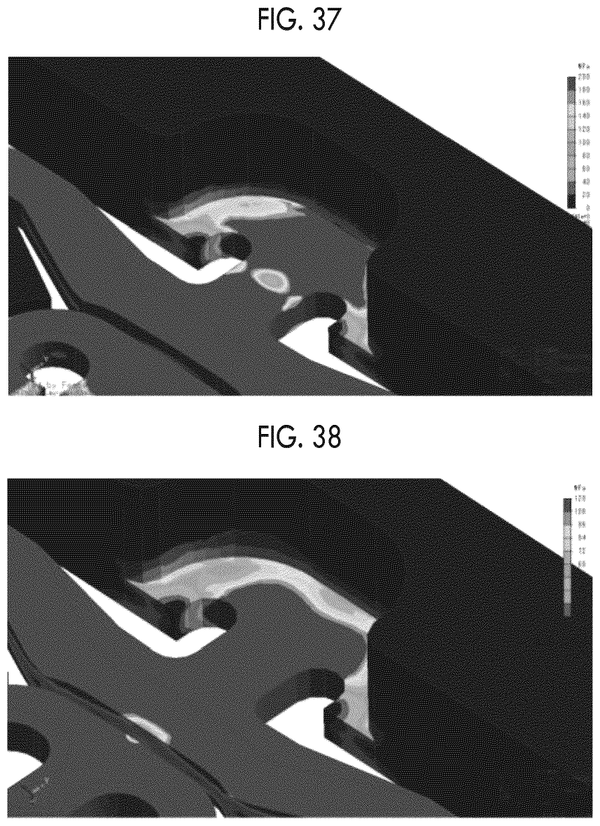

FIGS. 35 and 36 are contour diagrams showing stress distributions applied to the fixed frame connecting portion 26B of the MMD 2 according to the first embodiment. FIGS. 37 and 38 are contour diagrams showing stress distributions applied to the fixed frame connecting portion 26B of the MMD 2C according to the first comparative example. FIGS. 35 and 37 show stress distributions during the first resonance driving. FIGS. 36 and 38 show stress distributions during the second resonance driving.

In the first embodiment, it can be seen that the stress applied to the connection boundary 72 is relaxed, and the stress distribution during the first resonance driving and the stress distribution during the second resonance driving are similar to each other. In this way, the stress applied to the connection boundary 72 is relaxed not only during the driving around the second axis a₂ on which the slit 71 is disposed but also during the driving around the first axis a₁.

### Modification Example

Hereinafter, various modification examples of the first and second embodiments will be described.

In each of the embodiments described above, the MMD is a biaxial mirror device in which the mirror portion swings around two axes intersecting each other. However, the MMD may be a uniaxial mirror device in which the mirror portion swings around one axis.

In addition, in the above embodiment, the hardware configuration of the driving controller 4 can be variously modified. The processing unit of the driving controller 4 may be composed of one processor or may be composed of a combination of two or more processors of the same type or different types. The processor includes, for example, a CPU, a programmable logic device (PLD), or a dedicated electric circuit. As is well known, the CPU is a general-purpose processor that executes software (program) to function as various processing units. The PLD is a processor such as a field programmable gate array (FPGA) whose circuit configuration can be changed after manufacture. The dedicated electric circuit is a processor that has a dedicated circuit configuration designed to perform a specific process, such as an application specific integrated circuit (ASIC).

The following technology can be understood based on the above description.

### SUPPLEMENTARY NOTE 1

A mirror device comprising:
a mirror portion that has a reflecting surface for reflecting incident light;
a pair of first support portions that are connected to the mirror portion on a first axis parallel to the reflecting surface in a stationary state of the mirror portion and that swingably support the mirror portion around the first axis;
a driving unit that is connected to the pair of first support portions and that drives the mirror portion;
a fixed frame that is disposed to surround the driving unit; and
a pair of connecting portions that connect the driving unit to the fixed frame,
in which each of the pair of connecting portions has a slit,
the slit is disposed at a position line-symmetric with respect to the first axis or a second axis as a symmetry axis, the second axis being parallel to the reflecting surface in a stationary state of the mirror portion and intersecting the first axis, and
the fixed frame includes a pair of beam portions that are in contact with the pair of connecting portions and that extend in a first direction parallel to the symmetry axis, and a maximum value of a width of each of the pair of beam portions in a second direction parallel to the reflecting surface and orthogonal to the first direction is greater than a distance from an outermost end of the fixed frame in the second direction to the slit.

### SUPPLEMENTARY NOTE 2

The mirror device according to Supplementary Note 1,
in which the pair of connecting portions are disposed on the second axis at positions facing each other across the first axis.

### SUPPLEMENTARY NOTE 3

The mirror device according to Supplementary Note 2,
in which the slit is disposed on the second axis and extends in a direction parallel to the first axis.

### SUPPLEMENTARY NOTE 4

The mirror device according to Supplementary Note 3,
in which the connecting portion has a thickness smaller than a thickness of the fixed frame.

### SUPPLEMENTARY NOTE 5

The mirror device according to any one of Supplementary Notes 2 to 4,
in which a connection boundary between the connecting portion and the fixed frame has a protruding portion of which a part protrudes toward a slit side.

### SUPPLEMENTARY NOTE 6

The mirror device according to Supplementary Note 5,
in which the protruding portion is close to the slit on the second axis.

### SUPPLEMENTARY NOTE 7

The mirror device according to any one of Supplementary Notes 2 to 6, further comprises
a pair of movable frames that are connected to the first support portions and that disposed to face each other across the first axis, and
a pair of second support portions that are connected to the movable frames on the second axis and that swingably support the mirror portion, the pair of first support portions, and the pair of movable frames around the second axis,
in which the driving unit is connected to the pair of second support portions and is disposed to surround the pair of movable frames.

### SUPPLEMENTARY NOTE 8

The mirror device according to Supplementary Note 7,
in which the driving unit includes
   a pair of first actuators that are connected to the pair of second support portions, that face each other across the second axis, and that each include a piezoelectric element, and
   a pair of second actuators that are disposed to surround the pair of first actuators, that face each other across the first axis, and that each include a piezoelectric element.

### SUPPLEMENTARY NOTE 9

An optical scanning device comprising:
the mirror device according to any one of Supplementary Notes 2 to 8; and
a processor that drives the driving unit,
in which the processor causes the mirror portion to swing by applying a drive signal to the driving unit.

What is claimed is:

1. A mirror device comprising:
a mirror portion that has a reflecting surface for reflecting incident light;
a pair of first support portions that are connected to the mirror portion on a first axis parallel to the reflecting surface in a stationary state of the mirror portion and that swingably support the mirror portion around the first axis;
a driving unit that is connected to the pair of first support portions and that drives the mirror portion;
a fixed frame that is disposed to surround the driving unit; and
a pair of connecting portions that connect the driving unit to the fixed frame,
wherein each of the pair of connecting portions has a slit,
the slit is disposed at a position line-symmetric with respect to the first axis or a second axis as a symmetry axis, the second axis being parallel to the reflecting surface in a stationary state of the mirror portion and intersecting the first axis, and
the fixed frame includes a pair of beam portions that are in contact with the pair of connecting portions and that extend in a first direction parallel to the symmetry axis, and a maximum value of a width of each of the pair of beam portions in a second direction parallel to the reflecting surface and orthogonal to the first direction is greater than a distance from an outermost end of the fixed frame in the second direction to the slit.

2. The mirror device according to claim 1,
wherein the pair of connecting portions are disposed on the second axis at positions facing each other across the first axis.

3. The mirror device according to claim 2,
wherein the slit is disposed on the second axis and extends in a direction parallel to the first axis.

4. The mirror device according to claim 3,
wherein the connecting portion has a thickness smaller than a thickness of the fixed frame.

5. The mirror device according to claim 2,
wherein a connection boundary between the connecting portion and the fixed frame has a protruding portion of which a part protrudes toward a slit side.

6. The mirror device according to claim 3,
wherein a connection boundary between the connecting portion and the fixed frame has a protruding portion of which a part protrudes toward a slit side.

7. The mirror device according to claim 4,
wherein a connection boundary between the connecting portion and the fixed frame has a protruding portion of which a part protrudes toward a slit side.

8. The mirror device according to claim 5,
wherein the protruding portion is close to the slit on the second axis.

9. The mirror device according to claim 6,
wherein the protruding portion is close to the slit on the second axis.

10. The mirror device according to claim 7,
wherein the protruding portion is close to the slit on the second axis.

11. The mirror device according to claim 2, further comprising:
a pair of movable frames that are connected to the first support portions and that disposed to face each other across the first axis; and
a pair of second support portions that are connected to the movable frames on the second axis and that swingably support the mirror portion, the pair of first support portions, and the pair of movable frames around the second axis,
wherein the driving unit is connected to the pair of second support portions and is disposed to surround the pair of movable frames.

12. The mirror device according to claim 3, further comprising:
a pair of movable frames that are connected to the first support portions and that disposed to face each other across the first axis; and
a pair of second support portions that are connected to the movable frames on the second axis and that swingably support the mirror portion, the pair of first support portions, and the pair of movable frames around the second axis,
wherein the driving unit is connected to the pair of second support portions and is disposed to surround the pair of movable frames.

13. The mirror device according to claim 4, further comprising:
a pair of movable frames that are connected to the first support portions and that disposed to face each other across the first axis; and
a pair of second support portions that are connected to the movable frames on the second axis and that swingably support the mirror portion, the pair of first support portions, and the pair of movable frames around the second axis,
wherein the driving unit is connected to the pair of second support portions and is disposed to surround the pair of movable frames.

14. The mirror device according to claim 5, further comprising:
a pair of movable frames that are connected to the first support portions and that disposed to face each other across the first axis; and
a pair of second support portions that are connected to the movable frames on the second axis and that swingably support the mirror portion, the pair of first support portions, and the pair of movable frames around the second axis,
wherein the driving unit is connected to the pair of second support portions and is disposed to surround the pair of movable frames.

15. The mirror device according to claim 6, further comprising:
a pair of movable frames that are connected to the first support portions and that disposed to face each other across the first axis; and
a pair of second support portions that are connected to the movable frames on the second axis and that swingably support the mirror portion, the pair of first support portions, and the pair of movable frames around the second axis,
wherein the driving unit is connected to the pair of second support portions and is disposed to surround the pair of movable frames.

16. The mirror device according to claim 7, further comprising:
a pair of movable frames that are connected to the first support portions and that disposed to face each other across the first axis; and
a pair of second support portions that are connected to the movable frames on the second axis and that swingably support the mirror portion, the pair of first support portions, and the pair of movable frames around the second axis,
wherein the driving unit is connected to the pair of second support portions and is disposed to surround the pair of movable frames.

17. The mirror device according to claim 8, further comprising:
a pair of movable frames that are connected to the first support portions and that disposed to face each other across the first axis; and
a pair of second support portions that are connected to the movable frames on the second axis and that swingably support the mirror portion, the pair of first support portions, and the pair of movable frames around the second axis,
wherein the driving unit is connected to the pair of second support portions and is disposed to surround the pair of movable frames.

18. The mirror device according to claim 9, further comprising:
a pair of movable frames that are connected to the first support portions and that disposed to face each other across the first axis; and
a pair of second support portions that are connected to the movable frames on the second axis and that swingably support the mirror portion, the pair of first support portions, and the pair of movable frames around the second axis,
wherein the driving unit is connected to the pair of second support portions and is disposed to surround the pair of movable frames.

19. The mirror device according to claim 11,
wherein the driving unit includes
a pair of first actuators that are connected to the pair of second support portions, that face each other across the second axis, and that each include a piezoelectric element, and
a pair of second actuators that are disposed to surround the pair of first actuators, that face each other across the first axis, and that each include a piezoelectric element.

20. An optical scanning device comprising:
the mirror device according to claim 1; and
a processor that drives the driving unit,
wherein the processor causes the mirror portion to swing by applying a drive signal to the driving unit.
